(19) United States
(12) Patent Application Publication
(10) Pub. No.: US 2026/0147416 A1
(43) Pub. Date: May 28, 2026

(54) FORCE-FEEDBACK INPUT DEVICE

(71) Applicant: ALPS ALPINE CO., LTD., Tokyo (JP)

(72) Inventors: Jun ANDO, Miyagi (JP); Kiyoyuki ITO, Miyagi (JP); Ryotaro ANZO, Miyagi (JP)

(21) Appl. No.: 19/455,111

(22) Filed: Jan. 21, 2026

Related U.S. Application Data
(63) Continuation of application No. PCT/JP2024/008149, filed on Mar. 4, 2024.

(30) Foreign Application Priority Data
Jul. 26, 2023 (JP) 2023-121649

(51) Int. Cl. G06F 3/01; F03G 7/06

(52) U.S. Cl. CPC G06F 3/016; F03G 7/06143; F03G 7/066

(57) ABSTRACT

A force-feedback input device includes: a base; an operation member supported to be movable in a first direction with respect to the base; a shape memory alloy wire whose length changes when the operation member moves toward one side in the first direction; and a controller electrically coupled to the shape memory alloy wire, and having a processor and a memory storing computer-readable instructions, which when executed by the processor, cause the controller to change a current flowing through the shape memory alloy wire to change a length of the shape memory alloy wire when the operation member, moving toward the one side, reaches a first position. The controller is further caused to supply a measurement current to the shape memory alloy wire to measure a resistance value of the shape memory alloy wire, and detect a position of the operation member based on the resistance value.

### CROSS-REFERENCE TO RELATED APPLICATION

This application is a continuation application of International Application No. PCT/JP2024/008149 filed on Mar. 4, 2024, and designated the U.S., which is based upon and claims priority to Japanese Patent Application No. 2023-121649 filed on Jul. 26, 2023, the entire contents of which are incorporated herein by reference.

### BACKGROUND OF THE INVENTION

### 1. Field of the Invention

The present disclosure relates to a force-feedback input device.

### 2. Description of the Related Art

Conventionally, keyboards (input devices) that generate a pseudo click feeling by using a shape memory alloy wire when a key switch is pressed (see Patent Document 1) are known.
Patent Document 1: Japanese Unexamined Patent Publication No. 2020-035143

### SUMMARY OF THE INVENTION

A force-feedback input device according to one embodiment of the present disclosure includes:
a base;
an operation member supported so as to be movable in a first direction with respect to the base;
a shape memory alloy wire whose length changes when the operation member moves toward one side in the first direction; and
a controller electrically coupled to the shape memory alloy wire, the controller having a processor and a memory storing computer-readable instructions, which when executed by the processor, cause the controller to:
   change a current flowing through the shape memory alloy wire to change a length of the shape memory alloy wire when the operation member, moving toward the one side, reaches a first position,
wherein the controller is further caused to:
   supply a measurement current to the shape memory alloy wire to measure a resistance value of the shape memory alloy wire, and
   detect a position of the operation member based on the resistance value.

### BRIEF DESCRIPTION OF THE DRAWINGS

FIG. 1 is a diagram illustrating an example configuration of an input device.

FIG. 2 is a perspective view of an operation member that constitutes the input device of FIG. 1.

FIG. 3 is a flowchart illustrating an example flow of a force-feedback process.

FIG. 4 is a cross-sectional view of the input device of FIG. 1.

FIG. 5 is a diagram illustrating another example configuration of the input device.

FIG. 6 is a sectional perspective view of the input device of FIG. 5.

FIG. 7 is a right side view of the input device of FIG. 5.

FIG. 8 is a cross-sectional view of the input device of FIG. 5.

FIG. 9 is a diagram illustrating still another example configuration of the input device.

FIG. 10 is a cross-sectional view of the input device of FIG. 9.

### DETAILED DESCRIPTION OF THE PREFERRED EMBODIMENTS

However, the above-described keyboards may have a drawback in that their structure become complicated because the keyboards need to include a position detector that detects capacitance in order to detect that the key switch has been pressed.

Accordingly, it is desirable to provide a force-feedback input device having a simpler structure.

The above-described means can provide a force-feedback input device having a simpler structure.

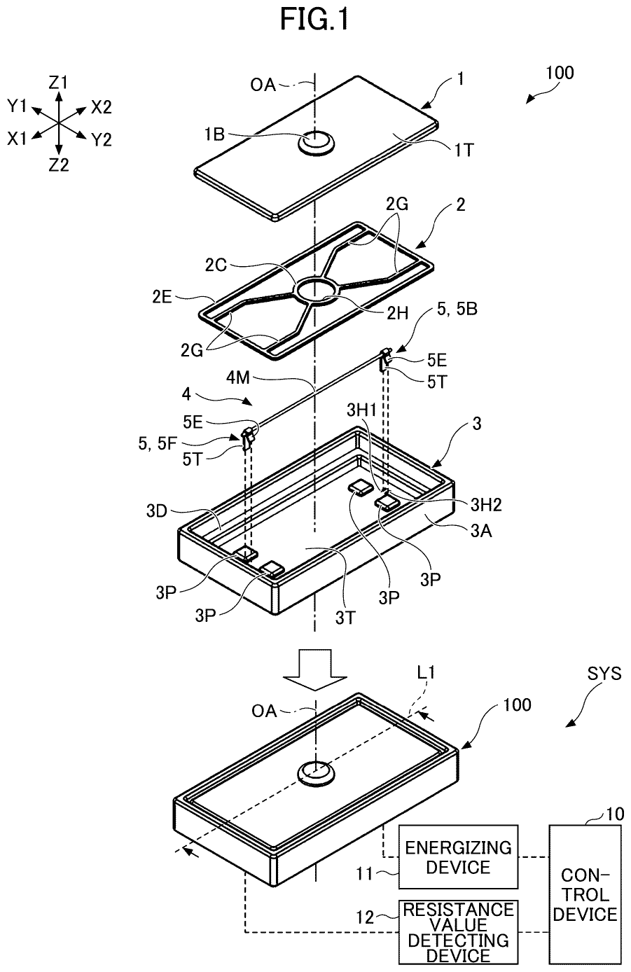

Hereinafter, a force-feedback input device 100 according to an embodiment of the present disclosure will be described with reference to the drawings. FIG. 1 is a diagram illustrating an example configuration of an input device 100. Specifically, the upper diagram of FIG. 1 (the diagram above the block arrow) is an exploded perspective view of the input device 100. The lower diagram of FIG. 1 (the diagram below the block arrow) is a schematic diagram of a force-feedback input system SYS configured from a control device (or controller) 10, an energizing device 11, a resistance value detecting device 12, and the input device 100, and includes a perspective view of the input device 100 in an assembled state.

In FIG. 1, X1 indicates one direction of an X-axis of a three-dimensional orthogonal coordinate system, and X2 indicates the other direction of the X-axis. Likewise, Y1 indicates one direction of a Y-axis of the three-dimensional orthogonal coordinate system, and Y2 indicates the other direction of the Y-axis. Similarly, Z1 indicates one direction of a Z-axis of the three-dimensional orthogonal coordinate system, and Z2 indicates the other direction of the Z-axis. In the present embodiment, the X1 side of the input device 100 corresponds to a front side (front face) of the input device 100, and the X2 side corresponds to a rear side (back face) of the input device 100. The Y1 side of the input device 100 corresponds to a left side of the input device 100, and the Y2 side corresponds to a right side of the input device 100. Further, the Z1 side of the input device 100 corresponds to an upper side of the input device 100, and the Z2 side corresponds to a lower side of the input device 100. The same applies to the other figures.

As illustrated in the upper diagram of FIG. 1, the input device 100 includes an operation member 1, a support member 2, a base 3, a shape memory alloy wire 4, and a conductive member 5.

The operation member 1 is a member that receives an operation force from an operator. In the illustrated example, the operation member 1 is formed of a synthetic resin and is supported by the support member 2 so as to be movable along an operation axis OA parallel to the first direction (the Z-axis direction).

The support member 2 is a member disposed between the operation member 1 and the base 3, and is configured to elastically support the operation member 1. In the illustrated example, the support member 2 is a leaf spring formed of a non-magnetic material, and includes an inner fixed portion 2C, an outer fixed portion 2E, and elastic arm portions 2G. The inner fixed portion 2C is a portion fixed to the operation member 1, the outer fixed portion 2E is a portion fixed to the base 3, and the four elastic arm portions 2G are elastically deformable portions that connect the inner fixed portion 2C and the outer fixed portion 2E.

The base 3 is a member that supports the support member 2. In the illustrated example, the base 3 is a member formed of a synthetic resin and has a substantially rectangular parallelepiped outer shape. Specifically, the base 3 is an open-top box-shaped member having an outer peripheral wall portion 3A and a bottom plate portion 3T. A rectangular ring-shaped pedestal portion 3D is formed on the inner side of the outer peripheral wall portion 3A, and four protrusions 3P, each having a substantially prismatic shape and protruding upward from the upper surface (inner bottom surface) of the bottom plate portion 3T, are provided. The outer fixed portion 2E of the support member 2 is fixed to the base 3 by an adhesive or the like while being placed on the pedestal portion 3D.

The shape memory alloy wire 4 is an example of a shape-memory actuator and constitutes a drive unit that drives the operation member 1. In the illustrated example, the shape memory alloy wire 4 increases in temperature when an electric current flows through the shape memory alloy wire 4, and contracts in accordance with the temperature rise. The drive unit can apply a force to the operation member 1 by utilizing the contraction of the shape memory alloy wire 4.

Specifically, when the shape memory alloy wire 4 is supplied with electric current, the shape memory alloy wire 4 is disposed in a straight stretched state. In this state, when the operation member 1 is pressed by the operator, the shape memory alloy wire 4 is arranged such that the shape memory alloy wire 4 is pulled downward by the operation member 1 moving downward, thereby being stretched.

The conductive member 5 is a member for supplying electricity to the shape memory alloy wire 4, and is formed of a magnetic metal such as iron. In the illustrated example, the conductive member 5 includes a front conductive member 5F that is fixed to one end (front end) of the shape memory alloy wire 4, and a rear conductive member 5B that is fixed to the other end (rear end) of the shape memory alloy wire 4. Each of the rear conductive member 5B and the front conductive member 5F includes a terminal portion 5T that is inserted through a through-hole 3H1 formed in the bottom plate portion 3T of the base 3, and a tip portion 5E that is inserted into a non-through hole 3H2 formed in the bottom plate portion 3T of the base 3. That is, the conductive member 5 is attached to the base 3 such that the terminal portions 5T protrude downward from the lower surface of the base 3. In FIG. 1, the through-hole 3H1 and the non-through hole 3H2 corresponding to the rear conductive member 5B are visible, but the through-hole 3H1 and the non-through hole 3H2 corresponding to the front conductive member 5F are not visible.

The control device 10 is configured to provide force feedback when the operation member 1 is operated by an operator. In the illustrated example, the control device 10 is a microcomputer that includes a CPU, a memory, and the like. Although in the illustrated example, the control device 10 is installed outside the base 3, the control device 10 may instead be installed inside the base 3. In such a case, the control device 10 may constitute one of the components of the input device 100.

The energizing device 11 is a device that supplies an electric current to the shape memory alloy wire 4. In the illustrated example, the energizing device 11 is configured to supply a current to the shape memory alloy wire 4 in accordance with control commands from the control device 10.

The resistance value detecting device 12 is a device that detects the electrical resistance value of the shape memory alloy wire 4. In the illustrated example, the resistance value detecting device 12 is configured to repeatedly detect the electrical resistance value of the shape memory alloy wire 4 at a predetermined detection period and output the detected value to the control device 10. Typically, the electrical resistance value of the shape memory alloy wire 4 increases as the shape memory alloy wire 4 is stretched, and also increases as the temperature of the wire rises.

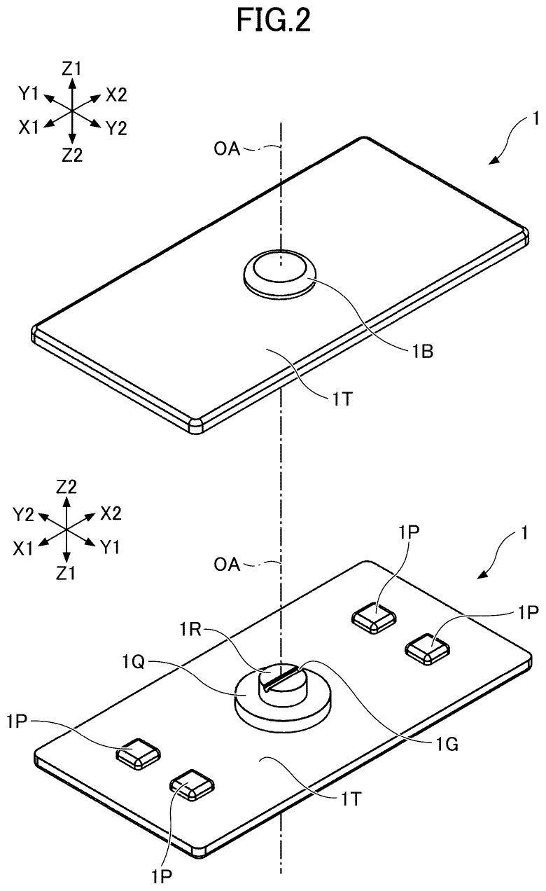

Here, with reference to FIG. 2, details of the operation member 1 will be described. FIG. 2 is a perspective view of the operation member 1. Specifically, the upper diagram of FIG. 2 is an upper perspective view of the operation member 1, and the lower diagram of FIG. 2 is a lower perspective view of the operation member 1.

As illustrated in FIG. 2, the operation member 1 includes, as viewed from above, a substantially rectangular flat plate portion 1T and a substantially hemispherical upper protrusion 1B formed so as to protrude upward from the center of the upper surface of the flat plate portion 1T. Further, as viewed from below, the operation member 1 includes four substantially prismatic first lower protrusions 1P formed to protrude downward from the lower surface of the flat plate portion 1T, a substantially cylindrical second lower protrusion 1Q formed to protrude downward from the center of the lower surface of the flat plate portion 1T, and a substantially cylindrical third lower protrusion 1R formed to protrude downward from the center of the lower surface of the second lower protrusion 1Q.

The upper protrusion 1B is a portion formed so as to extend along the operation axis OA, and is configured such that the operator can press the upper protrusion 1B to move the operation member 1 downward. That is, the upper protrusion 1B is positioned at the center of the flat plate portion 1T such that the operator can push the operation member 1 downward along the operation axis OA.

The first lower protrusions 1P are formed so as to face protrusions 3P formed on the upper surface of the bottom plate portion 3T of the base 3. The first lower protrusions 1P and the protrusions 3P may, for example, be formed such that a coil spring is disposed between the first lower protrusions 1P and the protrusions 3P. This serves to suppress tilting of the operation member 1 when the operation member 1 moves downward. In addition, the first lower protrusions 1P and the protrusions 3P may be formed to function as a stopper mechanism to prevent the operation member 1 from moving excessively downward.

The second lower protrusion 1Q is a portion to which the inner fixed portion 2C of the support member 2 is fixed. The third lower protrusion 1R is a portion that holds an intermediate portion 4M of the shape memory alloy wire 4. In the illustrated example, the inner fixed portion 2C of the support member 2 has a substantially annular shape as viewed from above, as illustrated in FIG. 1. The third lower protrusion 1R is configured to be inserted through a circular through-hole 2H formed at the center of the inner fixed portion 2C. The inner fixed portion 2C of the support member 2 is fixed to the operation member 1 with an adhesive or the like, in a state where the lower surface of the second lower protrusion 1Q is placed on the upper surface of the inner fixed portion 2C, and the third lower protrusion 1R is inserted through the through-hole 2H.

A groove 1G extending in a direction perpendicular to the operation axis OA (X-axis direction) is formed on the lower surface of the third lower protrusion 1R. In the illustrated example, the intermediate portion 4M of the shape memory alloy wire 4, located between one end (front end) and the other end (rear end) of the shape memory alloy wire 4, is fitted into the groove 1G and fixed to the operation member 1 with an adhesive or the like.

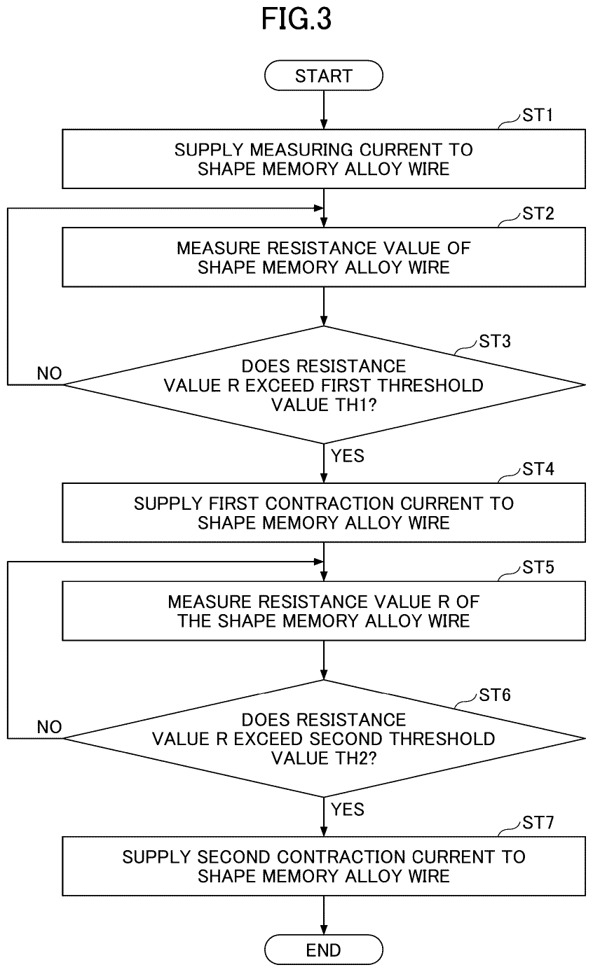

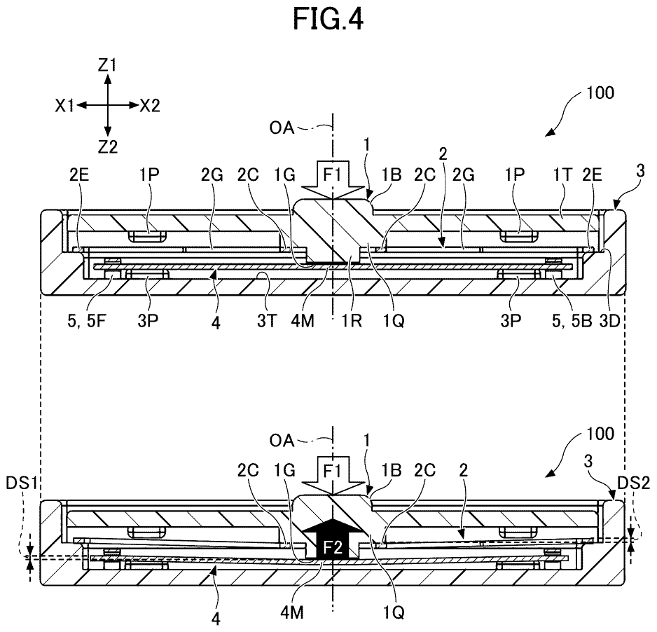

Next, with reference to FIGS. 3 and 4, the process in which the control device 10 supplies current to the shape memory alloy wire 4 to provide force feedback to an operator when the operation member 1 is operated (pressed) by the operator (hereinafter referred to as the “force feedback process”) will be described. FIG. 3 is a flowchart illustrating an example of a process of the force feedback process. In the illustrated example, the control device 10 is configured such that on and off states of the control device 10 can be switched, and the force feedback process is executed every time the state is switched from the off state to the on state. The control device 10 is also configured to repeatedly acquire the resistance values detected by the resistance value detecting device 12 at a predetermined detection period (i.e., the electrical resistance values of the shape memory alloy wire 4) at a predetermined sampling period.

FIG. 4 is a cross-sectional view of the input device 100. Specifically, FIG. 4 illustrates a cross section of the input device 100 in a virtual plane parallel to the XZ plane including the dashed line L1 in the lower diagram of FIG. 1, as viewed from the Y2 side. More specifically, the upper diagram of FIG. 4 illustrates the state of the input device 100 when the operation member 1 is not pressed downward, and the lower diagram of FIG. 4 illustrates the state of the input device 100 when the operation member 1 is pressed downward. In FIG. 4, for clarity, the force F1 exerted by the operator to push the operation member 1 downward is indicated by a white block arrow, and the force F2 exerted by the shape memory alloy wire 4 to push the operation member 1 back upward is indicated by a black block arrow.

First, the control device 10 supplies a measuring current to the shape memory alloy wire 4 (Step ST1). When the measuring current is supplied, the shape memory alloy wire 4 is held in a straight stretched state between the front conductive member 5F and the rear conductive member 5B. The measuring current is a current supplied to measure the resistance value R, which is the electrical resistance of the shape memory alloy wire 4, and has a predetermined magnitude.

Thereafter, the control device 10 measures the resistance value R of the shape memory alloy wire 4 (Step ST2). In the illustrated example, the control device 10 measures the resistance value R based on the output of the resistance value detecting device 12.

Thereafter, the control device 10 determines whether the resistance value R exceeds a first threshold value TH1 (Step ST3). The first threshold value TH1 corresponds to the electrical resistance of the shape memory alloy wire 4 when the length of the shape memory alloy wire 4 has reached a predetermined first length. The first length is typically longer than the length of the shape memory alloy wire 4 when the shape memory alloy wire 4 is in a straight stretched state by the supply of the measuring current.

Specifically, as illustrated in the lower diagram of FIG. 4, when the operation member 1 of the input device 100 is pressed downward by the operator, the intermediate portion 4M of the shape memory alloy wire 4 is pulled downward, stretching the shape memory alloy wire 4. When the length of the shape memory alloy wire 4 reaches the first length, the resistance value R exceeds the first threshold value TH1. At this time, as illustrated in the lower diagram of FIG. 4, the shape memory alloy wire 4 is typically bent into a substantially V-shape as viewed from the side. More specifically, the intermediate portion 4M of the shape memory alloy wire 4 moves downward by a distance DS1 compared to the state illustrated in the upper diagram of FIG. 4. In addition, the inner fixed portion 2C of the support member 2, which is fixed to the lower surface of the second lower protrusion 1Q of the operation member 1, moves downward by a distance DS2 compared to the state illustrated in the upper diagram of FIG. 4, as illustrated in the lower diagram of FIG. 4. Therefore, the support member 2 generates a force (restoring force) that tends to push the operation member 1 back upward.

When it is determined that the resistance value R does not exceed the first threshold value TH1 (NO in Step ST3), the control device 10 continues to monitor the resistance value R. On the other hand, when it is determined that the resistance value R exceeds the first threshold value TH1 (YES in Step ST3), the control device 10 supplies a first contraction current to the shape memory alloy wire 4 (Step ST4). The first contraction current is a current supplied to contract the shape memory alloy wire 4 and is larger than the measuring current.

When the first contraction current is supplied, the shape memory alloy wire 4, which has been bent into a substantially V-shape, contracts and tends to return to a straight stretched state. As a result, the operator pressing down the operation member 1 receives an upward force F2 from the shape memory alloy wire 4, and can feel a force feedback.

Thereafter, the control device 10 measures the resistance value R of the shape memory alloy wire 4 (Step ST5). That is, since the first contraction current is being supplied, the control device 10 repeatedly acquires, at a predetermined sampling period, the resistance value R of the shape memory alloy wire 4, which is at a higher temperature than when the measuring current is supplied.

Thereafter, the control device 10 determines whether the resistance value R exceeds a second threshold value TH2 (Step ST6). The second threshold value TH2 is typically larger than the first threshold value TH1, and corresponds to the electrical resistance of the shape memory alloy wire 4 when the length of the shape memory alloy wire 4, under the supply of the first contraction current, has reached a predetermined second length. The second length is typically longer than the first length.

Specifically, when the operation member 1 is pressed further downward by the operator of the input device 100, the intermediate portion 4M of the shape memory alloy wire 4 is pulled further downward, stretching the shape memory alloy wire 4. When the length of the shape memory alloy wire 4 reaches the second length, the resistance value R exceeds the second threshold value TH2. At this time, the shape memory alloy wire 4 is typically bent into a substantially V-shape as viewed from the side.

When it is determined that the resistance value R does not exceed the second threshold value TH2 (NO in step ST6), the control device 10 continues monitoring the resistance value R. On the other hand, when it is determined that the resistance value R exceeds the second threshold value TH2 (YES in step ST6), the control device 10 supplies a second contraction current to the shape memory alloy wire 4 (step ST7). The second contraction current is a current supplied to further contract the shape memory alloy wire 4, and is larger than the first contraction current.

When the second contraction current is supplied, the shape memory alloy wire 4 attempts to return to a straight stretched state with stronger contraction than when the first contraction current is supplied. Therefore, the operator pushing down the operation member 1 receives a stronger upward force than when the first contraction current is supplied, and can feel a force sensation different from that felt when the first contraction current is supplied.

Thus, the control device 10 can provide force feedback to the operator pressing the operation member 1 by increasing the current supplied to the shape memory alloy wire 4 when the resistance value R of the shape memory alloy wire 4 exceeds a predetermined value. Specifically, the control device 10 can provide a predetermined force feedback to the operator when the operator has pressed the operation member 1 along the operation axis OA by a predetermined distance.

The control device 10 may be configured to supply a measurement current to the shape memory alloy wire 4 when, while the first contraction current is being supplied to the shape memory alloy wire 4, a resistance value R of the shape memory alloy wire 4 falls below a third threshold TH3 (a value smaller than a first threshold TH1). This is to allow the control device to respond when the operator interrupts the pressing of the operation member 1.

Furthermore, the control device 10 may also be configured to supply the first contraction current to the shape memory alloy wire 4 when, while the second contraction current is being supplied to the shape memory alloy wire 4, the resistance value R of the shape memory alloy wire 4 falls below a fourth threshold TH4 (a value greater than the first threshold TH1 and smaller than a second threshold TH2). This is to allow the control device to respond when the operator reduces the pressing force F1 applied to the operation member 1.

Steps ST2 to ST4 or Steps ST5 to ST7 may be omitted. That is, the control device 10 may be configured to provide the operator with a single type of force feedback. Conversely, the control device 10 may be configured to provide the operator with three or more types of force feedback.

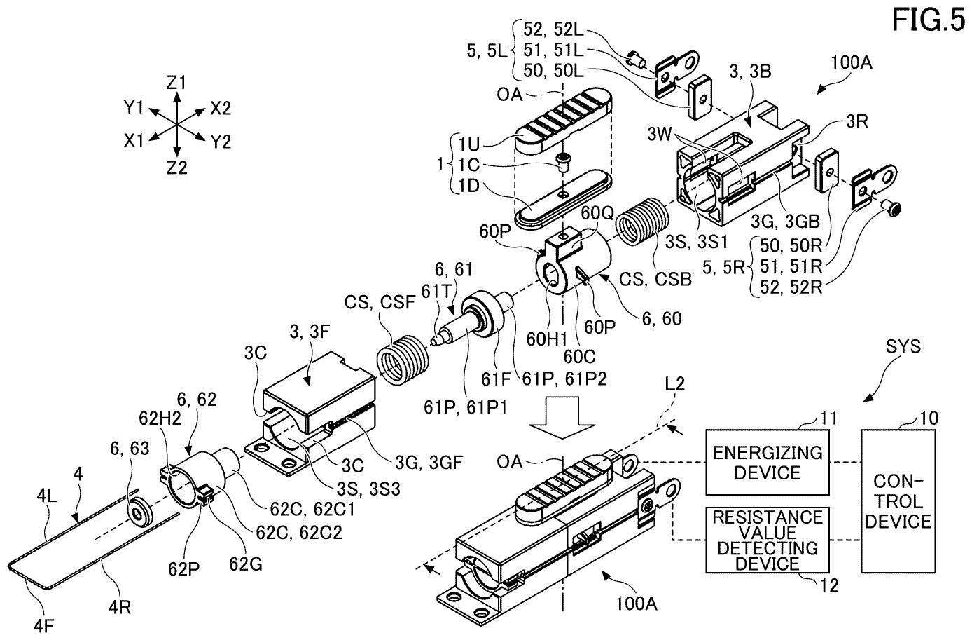

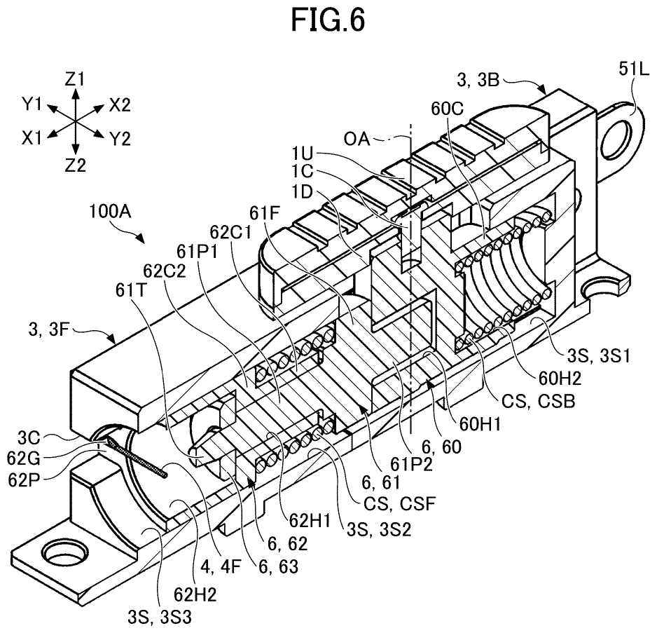

Next, with reference to FIGS. 5 and 6, another example configuration of the force-feedback input device 100, namely an input device 100A, will be described. FIG. 5 is a diagram illustrating the example configuration of the input device 100A. Specifically, the upper diagram of FIG. 5 (the diagram above the block arrow) is an exploded perspective view of the input device 100A. The lower diagram of FIG. 5 (the diagram below the block arrow) is a schematic diagram of a force-feedback input system SYS, which is composed of the control device 10, the energizing device 11, the resistance value detecting device 12, and the input device 100A, and includes a perspective view of the input device 100A in its assembled state.

FIG. 6 is a perspective cross-sectional view of the input device 100A. Specifically, FIG. 6 illustrates a cross section of the input device 100A in a virtual plane parallel to the XZ plane, including the dashed line L2 in the lower diagram of FIG. 5, as viewed from the Y2 side.

In the example illustrated in FIGS. 5 and 6, the input device 100A includes an operation member 1, a base 3, a shape memory alloy wire 4, a conductive member 5, a movable member 6, and a spring member CS.

The operation member 1 is a member that receives an operation force from an operator. In the illustrated example, the operation member 1 is supported by the shape memory alloy wire 4 such that the operation member 1 can move along an operation axis OA parallel to a first direction (Z-axis direction).

Specifically, the operation member 1 includes an upper operation member 1U, a lower operation member 1D, and a fastening member 1C. The fastening member 1C is a screw for fixing the lower operation member 1D to the movable member 6. The upper operation member 1U is fixed to the upper side of the lower operation member 1D fixed to the movable member 6 by adhesive or the like, and can cover the fastening member 1C.

The base 3 is a member configured to support the operation member 1 such that the base 3 can move in the first direction, and also configured to support the movable member 6 such that the base 3 can move in a second direction (X-axis direction) perpendicular to the first direction. In the illustrated example, the base 3 is formed of a synthetic resin, and includes a front base 3F and a rear base 3B. The base 3 also has a cavity 3S for accommodating another member (movable member 6) inside. On the side surfaces of the base 3, grooves 3G for guiding the shape memory alloy wire 4 are formed. Specifically, a front groove 3GF is formed on the side surface of the front base 3F, and a rear groove 3GB is formed on the side surface of the rear base 3B.

The shape memory alloy wire 4 is an example of a shape memory actuator, and constitutes a drive unit that drives the operation member 1 and the movable member 6. In the illustrated example, when current flows through the shape memory alloy wire 4, its temperature rises, and the shape memory alloy wire 4 contracts in accordance with the temperature increase. The drive unit can exert force on the operation member 1 and the movable member 6 by utilizing the contraction of the shape memory alloy wire 4. In the illustrated example, the shape memory alloy wire 4 is a single wire having a left portion 4L disposed on the left side of the movable member 6, a front portion 4F disposed on the front side of the movable member 6, and a right portion 4R disposed on the right side of the movable member 6.

The conductive member 5 is a member for conducting electricity to the shape memory alloy wire 4, and is formed of a magnetic metal such as iron. In the illustrated example, the conductive member 5 includes a metal member 50, a terminal member 51, and a fastening member 52. The fastening member 52 is a screw for fixing the metal member 50 and the terminal member 51 to the base 3. Specifically, the conductive member 5 includes a left conductive member 5L that fixes one end (left end) of the shape memory alloy wire 4, and a right conductive member 5R that fixes the other end (right end) of the shape memory alloy wire 4. The left conductive member 5L includes a left metal member 50L, a left terminal member 51L, and a left fastening member 52L; and the right conductive member 5R includes a right metal member 50R, a right terminal member 51R, and a right fastening member 52R. The left metal member 50L and the left terminal member 51L are fitted into a recess 3R (not visible in FIG. 5) formed on the left side surface of the rear base 3B, with the rear end of the left portion 4L of the shape memory alloy wire 4 interposed between the two members, and are fixed to the left side surface of the rear base 3B by the left fastening member 52L. Similarly, the right metal member 50R and the right terminal member 51R are fitted into a recess 3R formed on the right side surface of the rear base 3B, with the rear end of the right portion 4R of the shape memory alloy wire 4 interposed between the two members, and are fixed to the right side surface of the rear base 3B by the right fastening member 52R.

The movable member 6 is a member configured to move in accordance with the movement of the operation member 1. In the illustrated example, the movable member 6 is formed of a synthetic resin, and is supported by the base 3 such that the movable member 6 can move along a second direction (X-axis direction) perpendicular to the first direction (Z-axis direction).

The spring member CS is a member configured to apply a force along the second direction (X-axis direction) to the movable member 6. In the illustrated example, the spring member CS is a compression coil spring. Specifically, the movable member 6 includes a rear member 60, a central member 61, a front member 62, and a ring member 63, and the spring member CS includes a front spring member CSF and a rear spring member CSB.

The rear member 60 includes a cylindrical portion 60C, a pair of lateral protrusions 60P protruding laterally from the outer peripheral surface of the cylindrical portion 60C, and a substantially rectangular upper protrusion 60Q protruding upward from the outer peripheral surface of the cylindrical portion 60C. The cylindrical portion 60C is formed with a front cavity 60H1 for receiving the rear end of the central member 61 and a rear cavity 60H2 (see FIG. 6) for receiving the rear spring member CSB.

The central member 61 includes a columnar portion 61P, a flange portion 61F, and a tip portion 61T. Specifically, the columnar portion 61P includes a front columnar portion 61P1 disposed on the front side of the flange portion 61F and a rear columnar portion 61P2 disposed on the rear side of the flange portion 61F. The tip portion 61T is configured to extend forward from the front end of the front columnar portion 61P1. In the illustrated example, the columnar portion 61P, the flange portion 61F, and the tip portion 61T are all formed to be cylindrical. The diameters of the front columnar portion 61P1 and the rear columnar portion 61P2 are the same, the diameter of the flange portion 61F is larger than each of the diameters of the front and rear columnar portions 61P1 and 61P2, and the diameter of the tip portion 61T is smaller than each of the diameters of the front and rear columnar portions 61P1 and 61P2.

The front member 62 includes a cylindrical portion 62C and a pair of lateral protrusions 62P that protrude laterally from the outer peripheral surface of the cylindrical portion 62C. Specifically, the cylindrical portion 62C includes a rear cylindrical portion 62C1 disposed on the rear side and a front cylindrical portion 62C2 disposed on the front side. In the illustrated example, the cylindrical portion 62C is formed to be cylindrical, and the diameter of the front cylindrical portion 62C2 is larger than that of the rear cylindrical portion 62C1. The rear cylindrical portion 62C1 is formed with a rear cavity 62H1 (see FIG. 6) that receives the front columnar portion 61P1 of the central member 61, and the front cylindrical portion 62C2 is formed with a front cavity 62H2 that receives the ring member 63. Further, each of distal end surfaces of the pair of lateral protrusions 62P is formed with a groove 62G for guiding the shape memory alloy wire 4.

The ring member 63 is a member fixed to the tip portion 61T of the central member 61 within the front cavity 62H2 of the front member 62. In the illustrated example, the tip portion 61T is inserted into the ring member 63, and the ring member 63 and the tip portion 61T are fixed with adhesive. The ring member 63 may alternatively be screwed onto the tip portion 61T of the central member 61.

With this configuration, the front member 62 can slide rearward (toward the X2 side) over the front columnar portion 61P1 of the central member 61 while compressing the front spring member CSF, as illustrated in FIG. 6. On the other hand, the ring member 63 can prevent the front member 62 from coming off forward (toward the X1 side) from the front columnar portion 61P1 of the central member 61.

In the illustrated example, a cavity 3S (first cavity 3S1) that accommodates the rear spring member CSB, and the rear member 60 is formed in front of the rear base 3B. That is, the rear spring member CSB is disposed within the first cavity 3S1, between the inner bottom surface of the first cavity 3S1 and the inner bottom surface of the rear cavity 60H2, and is configured to be compressed and to generate a restoring force when the rear member 60 moves rearward (toward the X2 side) relative to the rear base 3B. Similarly, a cavity 3S (second cavity 3S2) that accommodates the front spring member CSF, the central member 61, and the front member 62 is formed behind the front base 3F. That is, the front spring member CSF is disposed within the second cavity 3S2, between the flange portion 61F of the central member 61 and the front cylindrical portion 62C2 of the front member 62, and is configured to be compressed and to generate a restoring force when the front member 62 moves rearward (toward the X2 side) relative to the central member 61.

Further, a cavity 3S (third cavity 3S3) that accommodates the front member 62, the ring member 63, and the tip portion 61T of the central member 61 is formed in front of the front base 3F. The front member 62 is configured to move rearward (in the X2 direction) within the third cavity 3S3 when the shape memory alloy wire 4 contracts. Specifically, a pair of cutout portions 3C that open forward are formed in the front base 3F, and the front member 62 is attached to the front base 3F such that the pair of lateral protrusions 62P engage with the pair of cutout portions 3C.

In addition, a pair of window portions 3W is formed on the side surface of the rear base 3B. The pair of window portions 3W is configured such that the pair of lateral protrusions 60P, which protrude laterally from the outer peripheral surface of the cylindrical portion 60C of the rear member 60, can move in the first direction (Z-axis direction). With this configuration, the rear member 60 can move in the first direction (Z-axis direction) within the rear base 3B without the lateral protrusions 60P contacting the rear base 3B. The lateral protrusions 60P can engage the intermediate portion 4M of the shape memory alloy wire 4 within the window portions 3W, thereby pulling the shape memory alloy wire 4 downward.

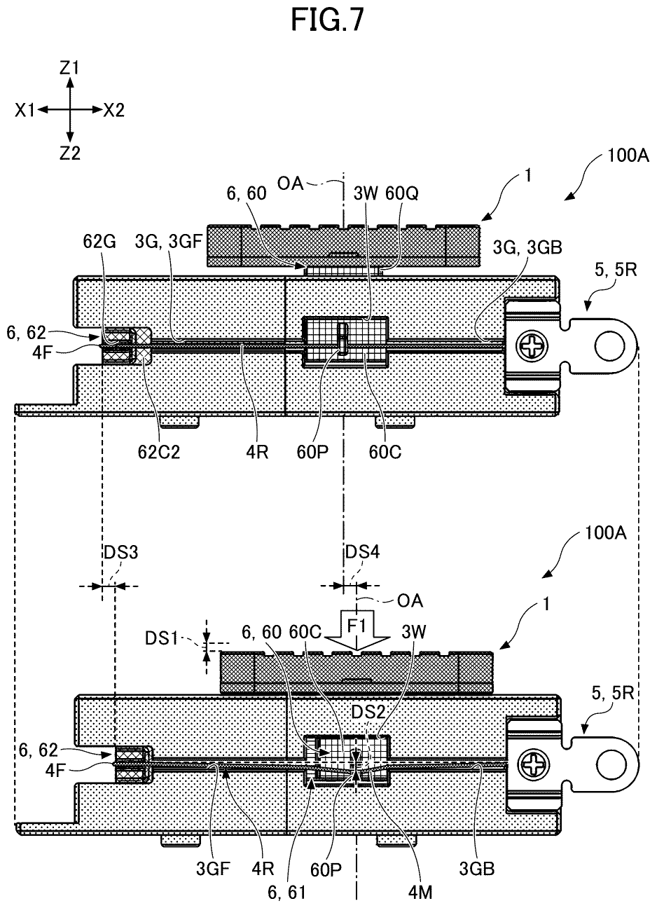

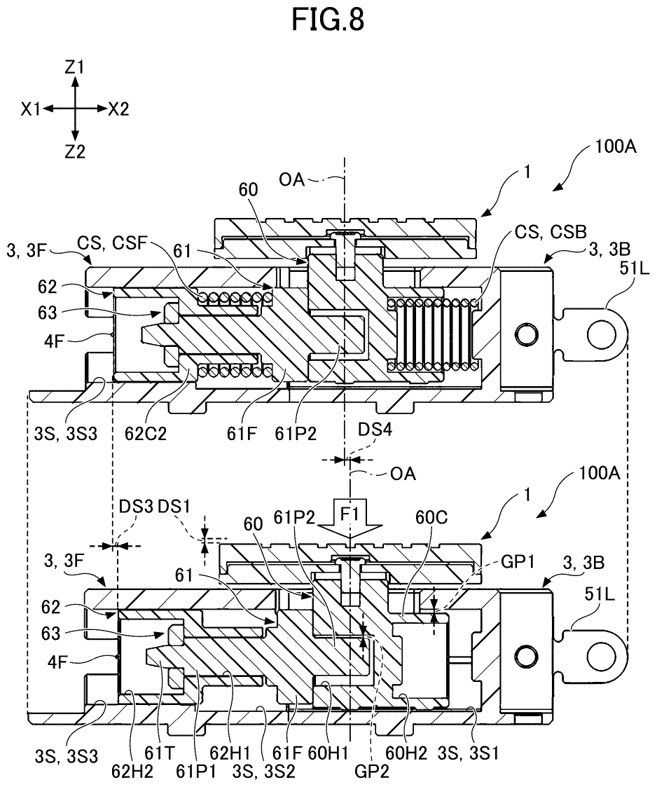

Next, referring to FIGS. 7 and 8, the movement of each member when the operator presses the operation member 1 of the input device 100A downward will be described. FIG. 7 is a right side view of the input device 100A. Specifically, the upper diagram of FIG. 7 is a right side view of the input device 100A when the operation member 1 is not pressed, and the lower diagram of FIG. 7 is a right side view of the input device 100A when the operation member 1 is pressed. For clarity, in FIG. 7, a fine cross pattern is applied to the operation member 1, a fine dot pattern is applied to the shape memory alloy wire 4, a grid pattern is applied to the rear member 60, a horizontal stripe pattern is applied to the central member 61, and a coarse cross pattern is applied to the front member 62. In addition, in FIG. 7, for clarity, the force F1 exerted by the operator to push the operation member 1 downward is indicated by a white block arrow.

FIG. 8 is a cross-sectional view of the input device 100A. Specifically, FIG. 8 is a view of the cross section of the input device 100A in a virtual plane parallel to the XZ plane including the dashed line L2 in the lower diagram of FIG. 5, as seen from the Y2 side, and corresponds to the sectional perspective view of FIG. 6. More specifically, the upper diagram of FIG. 8 is a cross-sectional view of the input device 100A when the operation member 1 is not pressed, and corresponds to the upper diagram of FIG. 7. The lower diagram of FIG. 8 is a cross-sectional view of the input device 100A when the operation member 1 is pressed, and corresponds to the lower diagram of FIG. 7. In addition, in FIG. 8, for clarity, the front spring member CSF and the rear spring member CSB are omitted. Furthermore, for clarity, the force F1 exerted by the operator to push the operation member 1 downward is indicated by a white block arrow.

As illustrated in the lower diagram of FIG. 7, when the operation member 1 is pressed downward by the operator and moves downward by a distance DS1, the rear member 60 of the movable member 6, to which the operation member 1 is fixed, also moves downward together with the operation member 1. Specifically, as illustrated in the lower diagram of FIG. 8, the rear member 60 moves downward while sliding on the rear surface of the flange portion 61F of the central member 61. At this time, the central member 61 does not move downward because its downward movement is restricted by the front member 62. The front member 62 is restricted from moving downward by the inner peripheral surface of the third cavity 3S3 of the front base 3F. As a result, as illustrated in the lower diagram of FIG. 8, a gap GP1 between the inner peripheral surface of the first cavity 3S1 of the rear base 3B and the upper end of the outer peripheral surface of the cylindrical portion 60C of the rear member 60 becomes larger, while a gap GP2 between the inner peripheral surface of the front cavity 60H1 of the cylindrical portion 60C and the upper end of the outer peripheral surface of the rear columnar portion 61P2 of the central member 61 becomes smaller. Therefore, as illustrated in the lower diagram of FIG. 7, the lateral protrusion 60P protruding rightward from the outer peripheral surface of the cylindrical portion 60C of the rear member 60 hooks the intermediate portion 4M of the right portion 4R of the shape memory alloy wire 4 inside the window 3W formed in the side surface of the rear base 3B, pulls the intermediate portion 4M downward by a distance DS2, and deforms the intermediate portion 4M into a V shape within the window portion 3W. The intermediate portion 4M is located between the rear end and the front end (the portion connected to the front portion 4F) of the right portion 4R of the shape memory alloy wire 4. The same applies to the left portion 4L of the shape memory alloy wire 4 (not visible in FIG. 7).

When the intermediate portion 4M is pulled downward by the distance DS2, the front portion 4F of the shape memory alloy wire 4 tends to move rearward by a distance DS3. As a result, the front member 62 is pulled rearward (toward the X2 side) by the front portion 4F of the shape memory alloy wire 4, and moves rearward. When the front member 62 moves rearward, the front spring member CSF (see FIG. 8) is compressed between the rear surface of the front cylindrical portion 62C2 of the front member 62 and the front surface of the flange portion 61F of the central member 61. Furthermore, the central member 61 is pressed rearward by the front spring member CSF and moves rearward, and the rear member 60 is pressed rearward by the central member 61, moving rearward by a distance DS4 while compressing the rear spring member CSB between the rear member 60 and the rear base 3B.

Furthermore, the control device 10 may supply the first contraction current to the shape memory alloy wire 4 when the operation member 1 has moved downward by the distance DS1. When the first contraction current is supplied, the shape memory alloy wire 4 contracts and, similarly to when the intermediate portion 4M is pulled downward, attempts to move the front portion 4F rearward. Therefore, as in the case where the intermediate portion 4M is pulled downward, the spring members CS (the front spring member CSF and the rear spring member CSB) are compressed, and the movable member 6 (the front member 62, the central member 61, and the rear member 60) moves rearward.

That is, similarly to the case of the input device 100, in the input device 100A, when the first contraction current is supplied, the intermediate portion 4M, which has been bent into an approximately V-shape, contracts and attempts to return to a straight stretched state as illustrated in the upper diagram of FIG. 7. Therefore, the operator pressing down the operation member 1 receives an upward force from the shape memory alloy wire 4 and can feel force feedback. Furthermore, in the input device 100A, when the first contraction current is supplied, the intermediate portion 4M, which has been bent into an approximately V-shape, contracts and attempts to return to a straight stretched state, thereby attempting to pull the front portion 4F rearward. As a result, the operator pressing down the operation member 1 receives a rearward force from the shape memory alloy wire 4, and can feel force feedback. In the input device 100A, the movement direction of the movable member 6 (X-axis direction) and the contraction direction of the shape memory alloy wire 4 (X-axis direction) are the same. Therefore, the moving distance of the rear member 60 (the operation member 1) of the movable member 6 in the X-axis direction caused by the contraction of the shape memory alloy wire 4 is greater than the moving distance of the rear member 60 (the operation member 1) of the movable member 6 in the Z-axis direction caused by the contraction of the shape-memory alloy wire 4. Consequently, the operator pressing down the operation member 1 of the input device 100A can feel a stronger force feedback than in the case of the input device 100.

Thus, similarly to the case of the input device 100, in the input device 100A, the control device 10 can provide force feedback to the operator pressing the operation member 1 by increasing the current supplied to the shape memory alloy wire 4 when the resistance value R of the shape memory alloy wire 4 exceeds a predetermined value. Specifically, the control device 10 can provide a predetermined force feedback to the operator when the operator presses the operation member 1 a predetermined distance along the operation axis OA.

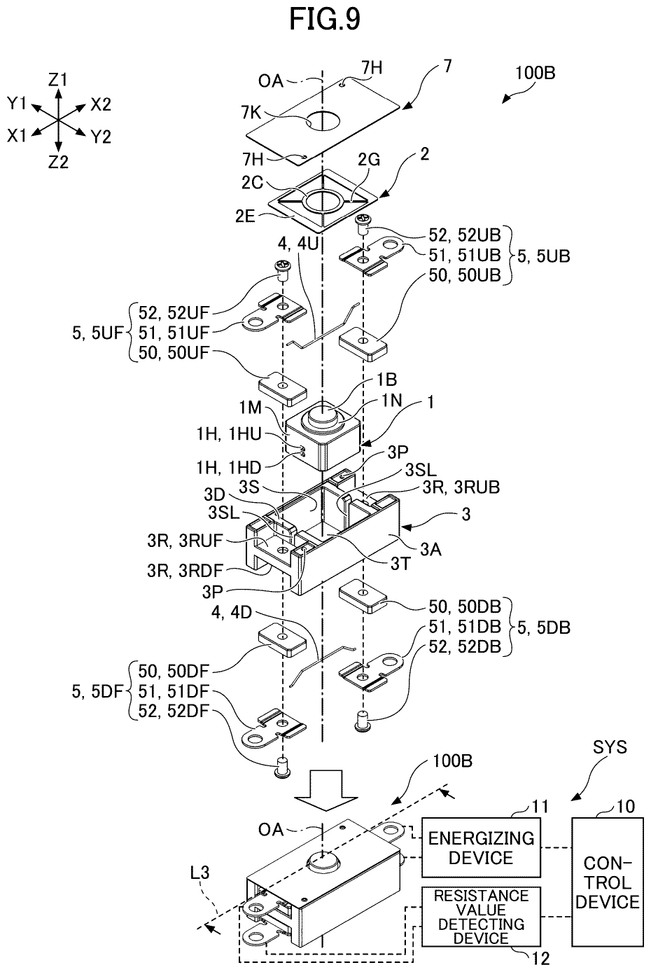

Next, referring to FIG. 9, another example configuration of the force-feedback input device 100, namely an input device 100B, will be described. FIG. 9 is a diagram illustrating an example configuration of the input device 100B. Specifically, the upper diagram of FIG. 9 (the diagram above the block arrow) is an exploded perspective view of the input device 100B. The lower diagram of FIG. 9 (the diagram below the block arrow) is a schematic diagram of a force-feedback input system SYS composed of the control device 10, the energizing device 11, the resistance value detecting device 12, and the input device 100B, and includes a perspective view of the input device 100B in its assembled state.

In the example illustrated in FIG. 9, the input device 100B includes an operation member 1, a support member 2, a base 3, a shape memory alloy wire 4, a conductive member 5, and a cover member 7.

The operation member 1 is a member that receives an operating force from the operator. In the illustrated example, the operation member 1 is formed of a synthetic resin and is supported by the support member 2 so as to be movable along an operation axis OA parallel to a first direction (Z-axis direction).

In the input device 100B, the operation member 1 includes a substantially rectangular parallelepiped main body 1M, a substantially cylindrical pedestal portion 1N formed so as to protrude upward from the center of the upper surface of the main body 1M, and a substantially hemispherical upper protrusion 1B formed so as to protrude upward from the center of the upper surface of the pedestal portion 1N. The main body 1M is provided with a through-hole 1H for guiding the shape memory alloy wire 4, the through-hole 1H extending through the main body 1M in the X-axis direction. Specifically, the through-hole 1H includes an upper through-hole 1HU and a lower through-hole 1HD provided at a position lower than the upper through-hole 1HU.

The support member 2 is a member disposed between the operation member 1 and the base 3, and is configured to elastically support the operation member 1. In the illustrated example, the support member 2 is a leaf spring formed of a non-magnetic material, and includes an inner fixed portion 2C, an outer fixed portion 2E, and elastic arm portions 2G. The inner fixed portion 2C is the portion fixed to the operation member 1, the outer fixed portion 2E is the portion fixed to the base 3, and the four elastic arm portions 2G are elastically deformable portions that connect the inner fixed portion 2C and the outer fixed portion 2E.

The base 3 is a member that supports the support member 2. In the illustrated example, the base 3 is formed of a synthetic resin and has a substantially rectangular parallelepiped outer shape. Specifically, the base 3 is an open-top box-shaped member having a peripheral wall portion 3A and a bottom plate portion 3T. Inside the peripheral wall portion 3A, a substantially rectangular ring-shaped pedestal portion 3D and a recess 3R for receiving the conductive member 5 are provided. Inside the substantially rectangular ring-shaped pedestal portion 3D, a cavity 3S for receiving the operation member 1 is provided. The outer fixed portion 2E of the support member 2 is fixed to the base 3 with adhesive or the like while being placed on the pedestal portion 3D.

The shape memory alloy wire 4 is an example of a shape memory actuator, and constitutes a drive unit that drives the operation member 1. In the illustrated example, the shape memory alloy wire 4 increases in temperature when a current flows through it, and contracts according to the rise in temperature. The drive unit can exert a force on the operation member 1 by utilizing the contraction of the shape memory alloy wire 4.

Specifically, the shape memory alloy wire 4 includes an upper wire 4U that is inserted through the upper through-hole 1HU of the operation member 1, and a lower wire 4D that is inserted through the lower through-hole 1HD of the operation member 1. In addition, the shape memory alloy wire 4 is movably disposed in the vertical direction within a pair of slits 3SL formed in the wall portion of the pedestal portion 3D of the base 3.

The conductive member 5 is a component for supplying electricity to the shape memory alloy wire 4 and is formed of a magnetic metal such as iron. In the illustrated example, the conductive member 5 includes a metal member 50, a terminal member 51, and a fastening member 52. Specifically, the conductive member 5 includes an upper front conductive member 5UF that fixes one end (front end) of the upper wire 4U, an upper rear conductive member 5UB that fixes the other end (rear end) of the upper wire 4U, a lower front conductive member 5DF that fixes one end (front end) of the lower wire 4D, and a lower rear conductive member 5 DB that fixes the other end (rear end) of the lower wire 4D. The upper front conductive member 5UF includes an upper front metal member 50UF, an upper front terminal member 51UF, and an upper front fastening member 52UF. The upper rear conductive member 5UB includes an upper rear metal member 50UB, an upper rear terminal member 51UB, and an upper rear fastening member 52UB. Similarly, the lower front conductive member 5DF includes a lower front metal member 50DF, a lower front terminal member 51DF, and a lower front fastening member 52DF, while the lower rear conductive member 5DB includes a lower rear metal member 50DB, a lower rear terminal member 51DB, and a lower rear fastening member 52DB. The upper front metal member 50UF and the upper front terminal member 51UF are fitted into the upper front recess 3RUF formed in the upper front portion of the base 3, with the front end portion of the upper wire 4U interposed between the two members, and are fixed to the upper front portion of the base 3 by the upper front fastening member 52UF. Similarly, the upper rear metal member 50UB and the upper rear terminal member 51UB are fitted into the upper rear recess 3RUB formed in the upper rear portion of the base 3, with the rear end portion of the upper wire 4U interposed between the two members, and are fixed to the upper rear portion of the base 3 by the upper rear fastening member 52UB. Likewise, the lower front metal member 50DF and the lower front terminal member 51DF are fitted into the lower front recess 3RDF formed in the lower front portion of the base 3, with the front end portion of the lower wire 4D interposed between the two members, and are fixed to the lower front portion of the base 3 by the lower front fastening member 52DF. The lower rear metal member 50DB and the lower rear terminal member 51DB are fitted into the lower rear recess 3RDB (not visible in FIG. 9) formed in the lower rear portion of the base 3, with the rear end portion of the lower wire 4D interposed between the two members, and are fixed to the lower rear portion of the base 3 by the lower rear fastening member 52DB.

The cover member 7 is a component arranged to cover the upper surface of the base 3. In the illustrated example, the cover member 7 is a plate-shaped metal member, and a circular opening 7K for allowing the upper protrusion 1B of the operation member 1 to pass through is formed at its central portion. Through-holes 7H are also formed at the front-right corner and the rear-left corner of the cover member 7. Cylindrical protrusions 3P, which are formed to protrude upward from the upper surface of the base 3, are inserted into the through-holes 7H. The joining between the base 3 and the cover member 7 is achieved, for example, by caulking the protrusions 3P inserted into the through-holes 7H. However, the joining between the base 3 and the cover member 7 may alternatively be achieved by applying an adhesive to the protrusions 3P inserted into the through-holes 7H.

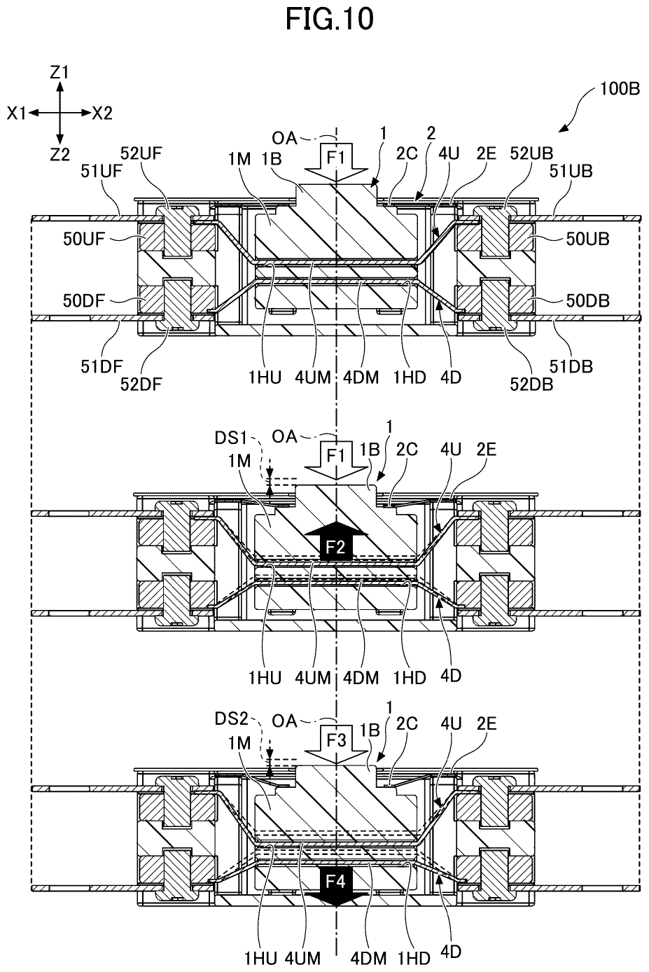

Next, with reference to FIG. 10, the movements of the respective components when the operation member 1 of the input device 100B is pressed downward by the operator will be described. FIG. 10 is a sectional view of the input device 100B. Specifically, FIG. 10 is a view of a cross-section of the input device 100B, taken from the Y2 side, in a virtual plane parallel to the XZ plane that includes the broken line L3 in the lower diagram of FIG. 9. More specifically, the upper diagram of FIG. 10 is a sectional view of the input device 100B when the operation member 1 is not being pressed, the middle diagram of FIG. 10 is a sectional view of the input device 100B when the operation member 1 is being pressed, and the lower diagram of FIG. 10 is a sectional view of the input device 100B when the operation member 1 is being pressed further. In FIG. 10, for clarity, the forces F1 and F3 exerted by the operator to push the operation member 1 downward are illustrated by white block arrows, and the forces F2 and F4 exerted by the shape memory alloy wire 4 to move the operation member 1 in the vertical direction are illustrated by black block arrows.

As illustrated in the middle diagram of FIG. 10, when the operation member 1 is pressed downward by the operator's force F1 and moves downward by a distance DS1, the upper wire 4U is pulled downward and stretched by the operation member 1 that moves downward. This is because, in the state where the operation member 1 is not being pressed, as illustrated in the upper diagram of FIG. 10, both ends (the front end and the rear end) of the upper wire 4U are positioned higher than an intermediate portion 4UM located between the front and rear ends, and the downward movement of the intermediate portion 4UM increases the height difference between the intermediate portion 4UM and each of the front and rear ends. Conversely, the lower wire 4D undergoes a reduction in tension when the operation member 1 moves downward. This is because, in the state where the operation member 1 is not being pressed, as illustrated in the upper diagram of FIG. 10, both ends (the front end and the rear end) of the lower wire 4D are positioned lower than an intermediate portion 4DM located between the front and rear ends, and the downward movement of the intermediate portion 4DM reduces the height difference between the intermediate portion 4DM and each of the front and rear ends. In the middle diagram of FIG. 10, for clarity, the positions of the lower wire 4D and the upper wire 4U when the operation member 1 is not being pressed are indicated by dashed lines. The same applies to the lower diagram of FIG. 10.

When the operation member 1 has moved downward by the distance DS1, the control device 10 may supply a first contraction current to the upper wire 4U. When the first contraction current is supplied, the upper wire 4U contracts and generates an upward force F2 that pushes the operation member 1 back upward. Accordingly, the operator who is pushing down the operation member 1 receives an upward force generated by the upper wire 4U and can experience force feedback.

Subsequently, as illustrated in the lower diagram of FIG. 10, when the operation member 1 is further pressed in by the operator's force F3 and moves downward by an additional distance DS2, the control device 10 may supply a second contraction current to the lower wire 4D. In the illustrated example, since the force F3 is a force for further pushing the operation member 1 downward while a first contraction current is being supplied to the upper wire 4U, the force F3 is greater than the force F1. In the illustrated example, at this time, the supply of the first contraction current to the upper wire 4U is stopped. When the second contraction current is supplied, the lower wire 4D contracts and generates a downward force F4 that pulls the operation member 1 further downward. Accordingly, the operation member 1 receives a downward force generated by the lower wire 4D, and the operator who is pressing down the operation member 1 can experience force feedback different from the force feedback felt when receiving the upward force from the upper wire 4U. Specifically, the operator can feel a sensation that the force required to push in the operation member 1 suddenly becomes smaller.

In the input device 100B, the control device 10 may be configured to supply a measurement current to the upper wire 4U to measure a resistance value of the upper wire 4U, and to detect a position of the operation member 1 based on the resistance value. However, the control device 10 may instead be configured to supply a measurement current to the lower wire 4D to measure a resistance value of the lower wire 4D, and to detect the position of the operation member 1 based on the resistance value. The control device 10 may further be configured to detect that the operation member 1 has moved downward by the distance DS1 by supplying a measurement current to the upper wire 4U to measure a resistance value of the upper wire 4U, and to detect that the operation member 1 has moved downward by the distance DS2 by supplying a measurement current to the lower wire 4D to measure a resistance value of the lower wire 4D. Alternatively, the control device 10 may be configured to detect that the operation member 1 has moved downward by the distance DS1 by supplying a measurement current to the lower wire 4D to measure a resistance value of the lower wire 4D, and to detect that the operation member 1 has moved downward by the distance DS2 by supplying a measurement current to the upper wire 4U to measure a resistance value of the upper wire 4U.

As described above, an input device 100 according to one embodiment of the present disclosure is a force-feedback input device and includes, as illustrated in FIG. 1, a base 3, an operation member 1 supported so as to be movable with respect to the base 3 in a first direction (the Z-axis direction, i.e., the vertical direction), a shape memory alloy wire 4 whose length changes when the operation member 1 moves toward one side in the first direction (the Z2 side, i.e., the lower side), and a control device 10 electrically coupled to the shape memory alloy wire 4 and configured to change a current flowing through the shape memory alloy wire 4 when the operation member 1, moving toward the one side (the Z2 side), reaches a first position (the position illustrated in the lower diagram of FIG. 4), thereby changing a length of the shape memory alloy wire 4. The control device 10 is configured to supply a measurement current to the shape memory alloy wire 4 to measure a resistance value R of the shape memory alloy wire 4, and to detect a position of the operation member 1 based on the resistance value R.

In this configuration, the shape memory alloy wire 4 not only functions as a drive unit that drives the operation member 1, but also functions as a position detection unit for detecting the position of the operation member 1 in the first direction (Z-axis direction). This is because the control device 10 can recognize the length of the shape memory alloy wire 4 by measuring the resistance value R of the shape memory alloy wire 4, and by recognizing the length of the shape memory alloy wire 4, it can recognize the position of the operation member 1 in the first direction (Z-axis direction). Accordingly, this configuration allows the position of the operation member 1 in the first direction (Z-axis direction) to be detected without separately providing a position sensor functioning as a position detection unit, thereby simplifying the structure of the input device 100. In other words, with this configuration, it is possible to determine whether or not the operation member 1 has been pressed without using a position sensor.

Further, the control device 10 may intermittently change a current flowing through the shape memory alloy wire 4 when the operation member 1 reaches the first position (the position illustrated in the lower diagram of FIG. 4), thereby intermittently contracting the shape memory alloy wire 4.

This configuration allows, for example, the operator to feel a sensation as if the operation member 1 is vibrating when the operation member 1 is pressed by a predetermined distance. In other words, this configuration enables the operator to easily recognize that the operation member 1 has been pressed by the predetermined distance.

Further, the control device 10 may change a current flowing through the shape memory alloy wire 4 to contract the shape memory alloy wire 4 when the operation member 1, having moved further toward the one side (Z2 side, lower side) beyond the first position (the position illustrated in the lower diagram of FIG. 4), reaches a second position.

This configuration allows, for example, the operator to feel a force different from the force felt when the operation member 1 is pressed to the first position when the operation member 1 is pressed to the second position in the first direction (Z-axis direction). As a result, the operator can easily distinguish between having pressed the operation member 1 to the first position and having pressed it to the second position.

Further, in another configuration of the input device 100, the input device 100A may include a movable member 6 supported so as to be movable in a second direction (X-axis direction, front-rear direction) intersecting the first direction (Z-axis direction, up-down direction) with respect to the base 3, as illustrated in FIGS. 5 and 6. In this case, the operation member 1 may be supported so as to be movable in the first direction (Z-axis direction) with respect to the movable member 6 (central member 61), as illustrated in the lower diagram of FIG. 8. Further, as illustrated in the lower diagram of FIG. 7, the shape memory alloy wire 4 may have a first portion (rear end of the right portion 4R) attached to the base 3 (rear base 3B) and a second portion (front end of the right portion 4R, front portion 4F) attached to the movable member 6 (front member 62), and may be configured such that contraction of the shape memory alloy wire 4 moves the movable member 6 toward one side in the second direction (X2 side, rear side). Moreover, the operation member 1, moving toward one side (Z2 side) in the first direction (Z-axis direction), may contact an intermediate portion 4M of the shape memory alloy wire 4 between the first portion (rear end of the right portion 4R) and the second portion (front end of the right portion 4R), thereby pulling and stretching the shape memory alloy wire 4. In the illustrated example, the operation member 1 is configured to move the rear member 60, which constitutes the movable member 6, downward together with the operation member 1. The rear member 60 is configured to hook the intermediate portion 4M of the shape memory alloy wire 4 with a pair of lateral protrusions 60P and to pull the intermediate portion 4M downward as the rear member 60 moves downward.

This configuration provides the effect that the force with which the operation member 1 pulls the intermediate portion 4M of the shape memory alloy wire 4 downward can be converted into a force that moves the movable member 6 rearward. Therefore, this configuration allows the operator to perceive a force different from the force felt in a configuration without the movable member 6. Moreover, this configuration typically allows the operator to feel a stronger force than in a configuration without the movable member 6. This is because, for the same amount of contraction of the shape memory alloy wire 4, the moving distance of the movable member 6 in the X-axis direction is typically greater than the moving distance of the operation member 1 in the Z-axis direction.

The shape memory alloy wire 4 may include a first shape memory alloy wire (upper wire 4U) and a second shape memory alloy wire (lower wire 4D), as illustrated in FIG. 9.

This configuration provides the effect that the operator can perceive a force different from the force obtained using a single shape memory alloy wire 4. For example, this configuration can provide the operator with a stronger force than the force obtained using a single shape memory alloy wire 4. The shape memory alloy wire 4 may also be configured with three or more shape memory alloy wires.

The control device 10 may be configured to contract the first shape memory alloy wire (upper wire 4U) by changing a current flowing through the first shape memory alloy wire when the operation member 1, moving toward one side (Z2 side, downward), reaches the first position (illustrated in the middle diagram of FIG. 10), and to contract the second shape memory alloy wire (lower wire 4D) by changing a current flowing through the second shape memory alloy wire when the operation member 1, moving further toward the one side (Z2 side, downward), reaches the second position (illustrated in the lower diagram of FIG. 10).

This configuration provides the effect that the force felt when the operation member 1 reaches the first position can be made different from the force felt when the operation member 1 reaches the second position. Therefore, this configuration can achieve, for example, a camera in which the operator can easily distinguish between a half-press state and a full-press state of a shutter button (an application of the input device 100).

The preferred embodiments of the present invention have been described in detail. However, the present invention is not limited to the above-described embodiments. Various modifications or substitutions may be applied to the above-described embodiments without departing from the scope of the present invention. Further, each of the features described with reference to the above-described embodiments may be suitably combined as long as there is no technical conflict.

For example, in the input device 100B described with reference to FIG. 9, the control device 10 may be configured to alternately change the current flowing through the first shape memory alloy wire (upper wire 4U) and the current flowing through the second shape memory alloy wire (lower wire 4D) when the operation member 1 has moved downward by the distance DS2 and reached the second position.

What is claimed is:

1. A force-feedback input device comprising:
a base;
an operation member supported so as to be movable in a first direction with respect to the base;
a shape memory alloy wire whose length changes when the operation member moves toward one side in the first direction; and
a controller electrically coupled to the shape memory alloy wire, the controller having a processor and a memory storing computer-readable instructions, which when executed by the processor, cause the controller to:
change a current flowing through the shape memory alloy wire to change a length of the shape memory alloy wire when the operation member, moving toward the one side, reaches a first position,
wherein the controller is further caused to:
supply a measurement current to the shape memory alloy wire to measure a resistance value of the shape memory alloy wire, and
detect a position of the operation member based on the resistance value.

2. The force-feedback input device according to claim 1, wherein the controller is further caused to:
intermittently change the current flowing through the shape memory alloy wire to intermittently contract the shape memory alloy wire when the operation member, moving toward the one side, reaches the first position.

3. The force-feedback input device according to claim 1, wherein the controller is further caused to:
change the current flowing through the shape memory alloy wire to change a length of the shape memory alloy wire when the operation member, after having moved further toward the one side beyond the first position, reaches a second position.

4. The force-feedback input device according to claim 1, further comprising:
a movable member supported so as to be movable in a second direction intersecting the first direction with respect to the base,
wherein the operation member is supported to be movable in the first direction with respect to the movable member;
the shape memory alloy wire has a first portion attached to the base and a second portion attached to the movable member, and is configured to move the movable member toward one side in the second direction when the shape memory alloy wire contracts; and
the operation member, moving toward the one side in the first direction, contacts an intermediate portion of the shape memory alloy wire between the first portion and the second portion to pull and stretch the shape memory alloy wire.

5. The force-feedback input device according to claim 1, wherein the shape memory alloy wire includes a first shape memory alloy wire and a second shape memory alloy wire.

6. The force-feedback input device according to claim 5, wherein the controller is further caused to:
change the current flowing through the first shape memory alloy wire to contract the first shape memory alloy wire when the operation member, moving toward the one side, reaches the first position, and
change the current flowing through the second shape memory alloy wire to contract the second shape memory alloy wire when the operation member, moving further toward the one side, reaches a second position.
